(19) United States
(12) Patent Application Publication
(10) Pub. No.: US 2005/0194404 A1
(43) Pub. Date: Sep. 8, 2005

(54) Bottled liquid cooler/dispenser

(76) Inventor: Robert G. Perdue, Ashford, WV (US)

Correspondence Address: LITMAN LAW OFFICES, LTD, PO BOX 15035, CRYSTAL CITY STATION, ARLINGTON, VA, 22215, US

(21) Appl. No.: 11/060,799

(22) Filed: Feb. 18, 2005

Related U.S. Application Data
(60) Provisional application No. 60/549,163, filed on Mar. 3, 2004.

(51) Int. Cl. B67D 5/62; B67D 5/06

(52) U.S. Cl. 222/146.1

(57) ABSTRACT

A bottled liquid cooler/dispenser configured for use by both physically challenged individuals and physically non-challenged individuals. The bottled liquid cooler/dispenser includes a housing configured to receive a bottled liquid container, a maneuvering aid gate including a drain and a faucet, the gate being pivotally attached to the housing, and an access door pivotally mounted on the front of the housing to swing between a closed and an open position. The bottled liquid cooler/dispenser is preferably compliant with the American's with Disabilities Act. The bottled liquid cooler/dispenser can include a liquid holder and a pump, and can include a cooling device and/or a heating device contained within the housing. The housing can be a generally rectangular housing with a front side and a bottom side. An access door can be positioned proximate the bottom side. The front side can have a recess with faucets for hot and cold liquids mounted thereon.

### CROSS-REFERENCE TO RELATED APPLICATION

This application claims the benefit of U.S. Provisional Patent Application Ser. No. 60/549,163, filed Mar. 3, 2004, which is incorporated herein by reference.

### BACKGROUND OF THE INVENTION

1. Field of the Invention

The present invention generally relates to drinking fountains and water coolers and, more particularly, to a bottled liquid cooler/dispenser configured for physically challenged individuals.

2. Description of Related Art

Bottled water cooler/dispensers or water coolers have been widely used in many settings including office buildings, homes, and restaurants, to supply clean drinking water, etc. In the 1960s the water cooler industry began to realize that there were physically challenged individuals who were confined to wheelchairs who had difficulty drinking from typical water fountains, and began developing more easily accessible wheelchair water coolers. In the 1990s, the American's with Disabilities Act (ADA), a civil rights legislation, was enacted to ensure an individual with a disability the same rights as a person without a disability: the right of access to physical environments, and to programs, goods, services, benefits, opportunities, and employment. The ADA comprehensively defined the rights and needs of the handicapped for access to many types of facilities. While this resulted in some dimensional and slight design changes to water coolers and drinking fountains in order to make them even more accessible to physically challenged individuals, it also recognized the needs of able bodied people and those with bending difficulties. The ADA declared that public facilities needed to provide both wheelchair accessible and standard height water cooler units.

The ADA states that one accessible drinking fountain shall be provided on each floor of a public facility, with the spout 36″ from the floor. The accessible drinking fountain should be on an accessible route. There should be a clear floor space of 30″ by 48″ in front of a free-standing or wall/post mounted drinking fountain (the wall/post mounted unit must also have a clear knee space 27″ high and 20″ wide) . The spout must be in the front of the unit 36″ from the floor and must provide a stream of water parallel to the front of the unit at least 4″ high to allow use of a cup. The controls should be easy to operate without grasping, pinching, or twisting of the wrist.

As the inventor is unaware of any free standing bottled liquid cooler/dispenser that complies with ADA requirements, a need exists to provide a bottled liquid cooler/dispenser that complies with ADA requirements.

The related art is represented by the following references of interest.

U.S. Pat. No. 2,871,675, issued Feb. 3, 1959 to Richard T. Cornelius, describes a beverage cooler and dispenser. The Cornelius patent does not suggest a bottled liquid cooler/dispenser according to the claimed invention.

U.S. Pat. No. 3,269,143, issued Aug. 30, 1966 to Mark Gasparovich, describes a self-contained liquid dispenser. The Gasparovich patent does not suggest a bottled liquid cooler/dispenser according to the claimed invention.

U.S. Pat. No. 3,541,808, issued Nov. 24, 1970 to Vincent Materese, describes a drinking fountain. The Materese patent does not suggest a bottled liquid cooler/dispenser according to the claimed invention.

U.S. Pat. No. 4,081,134, issued Mar. 28, 1978 to Henry G. Anderson, describes a drinking fountain which is adjustable in height to accommodate persons of different heights and persons confined to wheelchairs. The Anderson patent does not suggest a bottled liquid cooler/dispenser according to the claimed invention.

U.S. Pat. No. 4,295,609, issued Oct. 20, 1981 to Frank Brown, Jr., describes a wall mounted drinking fountain with a push bar actuator operable and usable by a handicapped occupant of a wheel chair without assistance by others. The Brown, Jr. patent does not suggest a bottled liquid cooler/dispenser according to the claimed invention.

U.S. Pat. No. 4,699,188, issued Oct. 13, 1987 to Henry E. Baker et al., describes a hygienic liquid dispensing system. The Baker et al. patent does not suggest a bottled liquid cooler/dispenser according to the claimed invention.

U.S. Pat. No. 4,723,688, issued Feb. 9, 1988 to Edward A. Munoz, describes a beverage container and cooler/dispenser. The Munoz patent does not suggest a bottled liquid cooler/dispenser according to the claimed invention.

U.S. Pat. No. 4,783,002, issued Nov. 8, 1988 to Doyle Raymer et al., describes a barrier free drinking fountain. The Raymer et al. patent does not suggest a bottled liquid cooler/dispenser according to the claimed invention.

U.S. Pat. No. 4,866,945, issued Sep. 19, 1989 to Richard S. Bender et al., describes a countertop cooler. The Bender et al. does not suggest a bottled liquid cooler/dispenser according to the claimed invention.

U.S. Pat. No. 4,885,081, issued Dec. 5, 1989 to Bruce J. Oliver, describes a drinking water delivery system with a purity indicator. The Oliver patent does not suggest a bottled liquid cooler/dispenser according to the claimed invention.

U.S. Pat. No. 4,940,164, issued Jul. 10, 1990 to Mark W. Hancock et al., describes a beverage cooler and cooler/dispenser. The Hancock et al. patent does not suggest a bottled liquid cooler/dispenser according to the claimed invention.

U.S. Pat. No. 4,958,747, issued Sep. 25, 1990 to Kerney T. Sheets, describes a bottled water dispenser. The Sheets patent does not suggest a bottled liquid cooler/dispenser according to the claimed invention.

U.S. Pat. No. 5,064,097, issued Nov. 12, 1991 to Larry Brog et al., describes a compact water purification and beverage dispensing apparatus. The Brog et al. patent does not suggest a bottled liquid cooler/dispenser according to the claimed invention.

U.S. Pat. No. 5,184,476, issued Feb. 9, 1993 to Andre Desrosiers et al., describes a counter-height water dispenser. The Desrosiers et al. patent does not suggest a bottled liquid cooler/dispenser according to the claimed invention.

U.S. Pat. No. 5,607,211, issued Mar. 4, 1997 to David B. Henninger et al., describes a fountain beverage center. The Henninger et al. patent does not suggest a bottled liquid cooler/dispenser according to the claimed invention.

U.S. Pat. No. 6,209,753 B1, issued Apr. 3, 2001 to Hee-Bum Ohu, describes a water dispenser for upright stand type water bottles. The Ohu patent does not suggest a bottled liquid cooler/dispenser according to the claimed invention.

U.S. Pat. No. 6,237,345 B1, issued May 29, 2001 to Jeffrey M. Kalman et al., describes a water dispenser for upright stand type water bottles. The Kalman et al. patent does not suggest a bottled liquid cooler/dispenser according to the claimed invention.

U.S. Pat. No. 6,241,126 B1, issued Jun. 5, 2001 to Andrew Goodman, describes a personal desk top beverage dispenser. The Goodman patent does not suggest a bottled liquid cooler/dispenser according to the claimed invention.

U.S. Pat. No. 6,433,334 B1, issued Sep. 3, 2002 to Chun Kuen Sham John, describes a comestible fluid dispenser apparatus and method. The John patent does not suggest a bottled liquid cooler/dispenser according to the claimed invention.

U.S. Pat. No. 6,508,070 B1, issued Jan. 21, 2001 to David G. Palmer, describes a water chiller. The Palmer patent does not suggest a bottled liquid cooler/dispenser according to the claimed invention.

Europe Patent Application Publication No. 0 253 029 A1, published Jan. 20, 1988, describes a distilled drinking water fountain. The Europe '029 application does not suggest a bottled liquid cooler/dispenser according to the claimed invention.

Japan Patent Application Publication No. 3-273431, published Dec. 4, 1991, describes an automatic vending machine. The Japan '481 application does not suggest a bottled liquid cooler/dispenser according to the claimed invention.

None of the above inventions and patents, taken either singly or in combination, is seen to describe the instant invention as claimed. Thus a bottled water cooler/dispenser solving the aforementioned problems is desired.

### SUMMARY OF THE INVENTION

The present invention is a bottled liquid cooler/dispenser configured for use by both physically challenged individuals and physically non-challenged individuals. The bottled liquid cooler/dispenser includes a housing configured to receive a bottled liquid container, a maneuvering aid gate including a drain and a faucet, the gate being pivotally attached to the housing, and an access door pivotally mounted on the front of the housing to swing between a closed and an open position. The bottled liquid cooler/dispenser is preferably compliant with the American's with Disabilities Act.

The bottled liquid cooler/dispenser can include a liquid holder and a pump, and can include a cooling device and/or a heating device contained within the housing. The housing can be a generally rectangular housing with a front side and a bottom side. An access door can be positioned proximate the bottom side.

A recess can be on the front side with a faucet for hot liquid mounted on the recess. The faucet for hot liquid can have a handle with indicia to enable users to quickly identify whether said faucet is for hot liquid, a handle with coloring to enable users to quickly identify whether said faucet is for hot liquid, or and/or a handle with Braille to enable users to quickly identify whether said faucet is for hot liquid. A faucet for cold liquid can also be mounted on the recess. The faucet for cold liquid can include a handle with indicia to enable users to quickly identify whether said faucet is for cold liquid, a handle with coloring to enable users to quickly identify whether said faucet is for cold liquid, and/or a handle with Braille to enable users to quickly identify whether said faucet is for cold liquid.

The maneuvering aid gate has a top and a drain positioned within a concave surface proximate the top of the maneuvering aid gate. The maneuvering aid gate can have a push bar for activating the fountain when said maneuvering aid gate is in a closed position. The cooler/dispenser can be configured as a gravity liquid cooler/dispenser when the maneuvering aid gate is in the closed position. The maneuvering aid gate can have a push bar for activating the fountain when said maneuvering aid gate is an open position. The cooler/dispenser can be configured to pump liquid from a holder to the faucet when the maneuvering aid gate is in the open position.

### BRIEF DESCRIPTION OF THE DRAWINGS

FIG. 1 is an environmental, perspective view of bottled liquid cooler/dispenser being used by a physically challenged individual according to the present invention.

FIG. 2 is front perspective view of the bottled liquid cooler/dispenser shown in FIG. 1.

FIG. 3 is cross-sectional right side view side vie: along line 3-3 of the bottled liquid cooler/dispenser shown in FIG. 2.

FIG. 4 is a front perspective view of the bottled liquid cooler/dispenser shown in FIG. 2 with the gate swung outwardly and the access door swung open.

Similar reference characters denote corresponding features consistently throughout the attached drawings.

### DETAILED DESCRIPTION OF THE PREFERRED EMBODIMENTS

The present invention is a bottled liquid cooler/dispenser. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

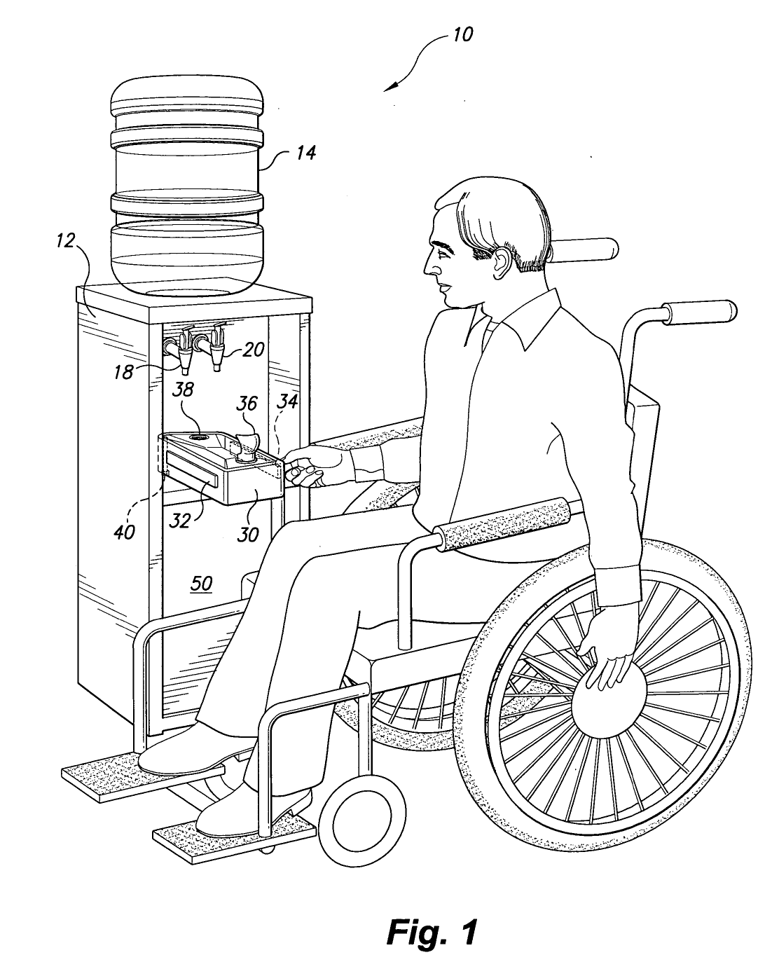

Referring to the drawings, to the drawings, FIG. 1 shows a bottled liquid cooler/dispenser 10 according to the present invention. The cooler/dispenser 10 is being used by a physically challenged individual P in a wheelchair W. The individual P has swung a maneuvering aid gate 30 of the cooler/dispenser 10 to an open position to facilitate access by the individual P to a fountain 36 on the gate 30. The individual P may then conveniently obtain a drink from the fountain 36 by mouth or through the use of a cup (not shown). The cooler/dispenser 10 is also configured to enable individuals who are not physically challenged to utilize the fountain 36 when it is positioned in a closed position. Such individual (physically challenged or not physically challenged) may also obtain drinks from other outlets 18 and 20 that may be found on the cooler/dispenser 10.

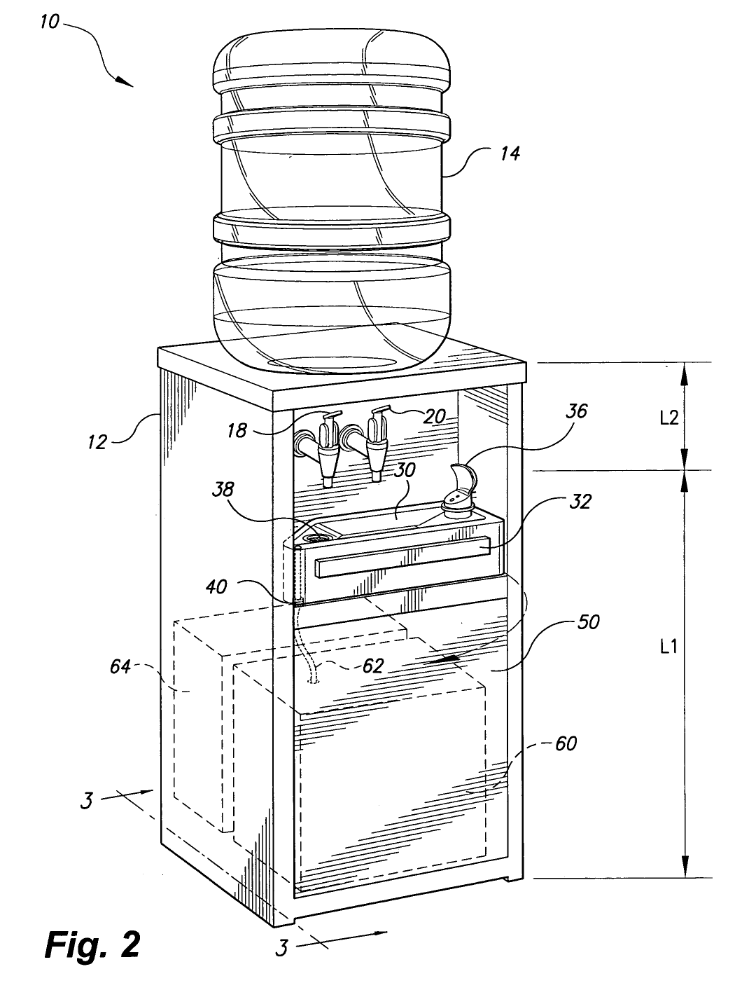

As shown in FIGS. 2-4, the cooler/dispenser 10 includes a generally rectangular housing or cabinet 12 with front, back, top, bottom, left, and right sides. The top side is configured for replaceably receiving a bottled container 14. The bottled container 14 is preferably prefilled with liquid water, such as distilled, spring, filtered, etc. However, the bottled container 14 may be filled with any type of potable liquid. The bottled container 14 may be a typical bottled container that preferably holds a volume of between about three to five gallons of liquid. The front of the housing 12 includes a recess 16 contained therein upon which may be mounted a faucet 18 for hot (about 140° to 190° F.) liquid and a faucet 20 for chilled (about 40° to 50° F.) liquid.

The faucets 18 and 20 each include handles which may be configured with some type of indicia, coloring, and/or Braille to enhance the ability of users to quickly identify which faucet corresponds to hot or cold. For example, the faucet 18 could have a red coloring, have alphanumeric indicia hot printed, thereon, and/or have the message hot provided as Braille on the handle of the faucet 18. Similarly, the faucet 20 could have a blue coloring, have alphanumeric indicia cold printed thereon, and/or have the message cold provided as Braille on the handle of the faucet 20.

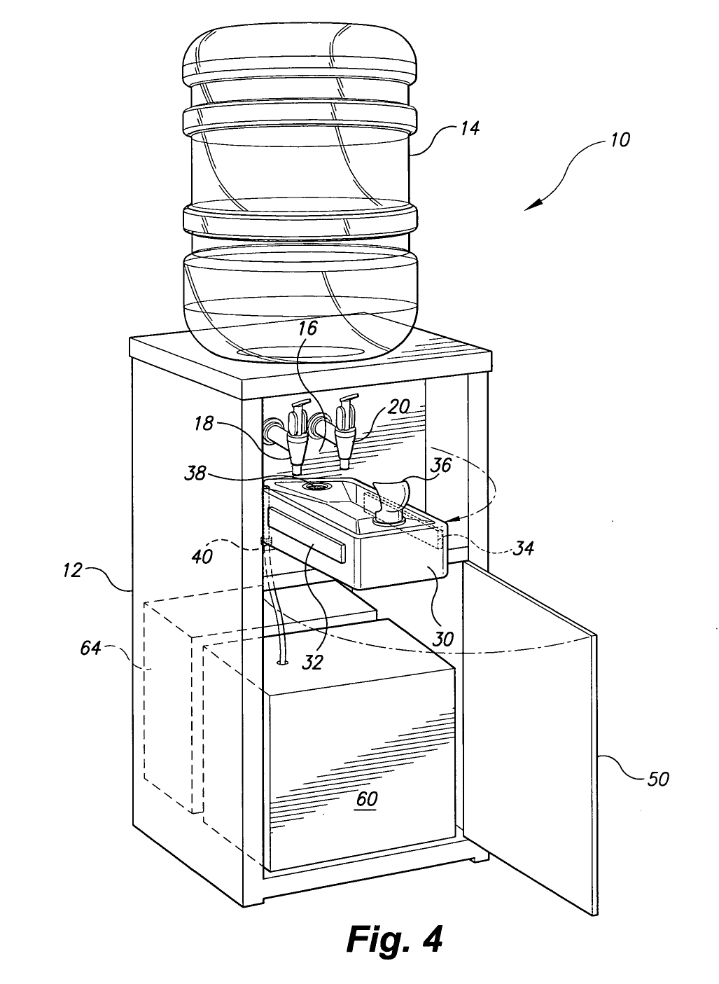

As described above, the cooler/dispenser 10 includes maneuvering aid gate 30 pivotally mounted on the front of the housing 12. The maneuvering aid gate 30 includes a fountain 3 and a drain 38. The drain 38 is positioned within a concave surface proximate the top of the gate 30. The gate 30 also includes a push bar 32 for activating the fountain 36 when the gate 30 is in a closed position (see FIG. 2) and a push bar 3 for activating the fountain 36 when the gate 30 is in an open position (see FIGS. 1 and 4). When the gate 30 is closed the cooler/dispenser 10 is configured as a gravity liquid cooler/dispenser 10 and when the gate 30 is open, the cooler/dispenser 10 is configured to pump the liquid from the holder 52 to the faucet 36.

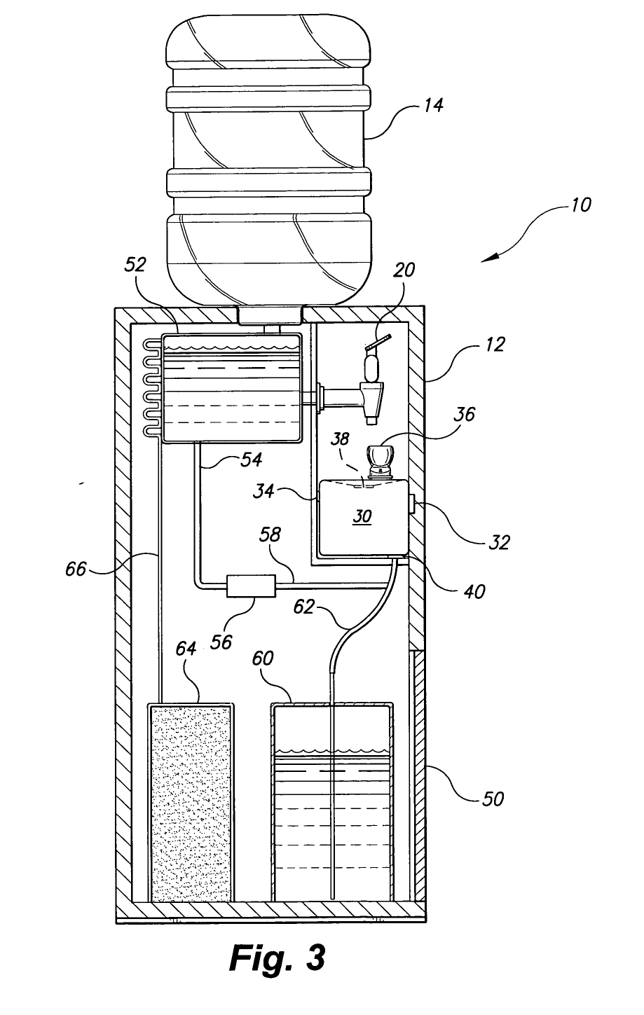

The gate 30 is pivotally attached to the housing 12 by a pivotal bearing 40. The pivotal bearing 40 is configured to allow tubing 58 (see FIG. 3) for the fountain 36 and tubing 62 for the drain to pass through. While the gate 30 is configured in a generally rectangular form, the particular shape of the gate 30 may be varied according to the desires of the user. The gate 30 is preferably made of a plastic material, but may be made of any durable material.

The front of the housing 12 also includes an access door 50 positioned proximate the bottom of the cooler/dispenser 10. The door 50 may be opened to facilitate access to a catch bucket 60. The catch bucket 60 receives liquid that passes through the drain 38 and the tube 62 connecting the drain 38 to the catch bucket 60. The volume of the catch bucket 60 is preferably two gallons or more.

The top of the housing 12 includes an opening configured to receive and support a bottled container 14 in an inverted manner. The container 14 is interconnected with a liquid holder 52. The liquid holder 52 is interconnected with the faucets 18 and 20 via tubing, and is interconnected with the maneuvering aid gate 30 via tubing 54, pump 56, and tubing 58. Liquid may be selectively dispensed from the liquid holder 52 using either one of the faucets 18 and 20 on the front of the dispensing housing, or by using the faucet 36 on the maneuvering aid gate 30. The faucets 18 and 20 are preferably positioned about half way along the vertical length of the holder 52 to provide an indication to users of the cooler/dispenser 10 that liquid provided from the container 14 to the cooler/dispenser 10 will end shortly after liquid is no longer available from the faucets 18 and 20. The liquid holder 52 can be made from polyethelyne with integrally molded fittings.

As described above, when the gate 30 is closed the cooler/dispenser 10 is configured as a gravity liquid cooler/dispenser 10 and liquid is provided to the faucet 36 by gravity. When the gate 30 is open, the cooler/dispenser 10 is configured to pump the liquid from the holder 52 to the faucet 36 through use of the pump 56.

The housing 12 also includes a cooling device 64 and may also include a heating device (not shown). The cooling device 64 may be may be a conventional compressor/refrigeration unit or other known means for cooling a volume of liquid, without affecting the scope of the invention. For example, the cooling device 64 may be a convection cooled condenser including a spring mounted hermetically sealed compressor and may include an automatic overload protector. No lubrication is necessary and refrigeration may be controlled by an accurately calibrated capillary tube. A thermoelectric cooling type of cooling device may also be used. The cooler/dispenser may be equipped with a heating device (not shown) to enable the cooler/dispenser to provide hot liquid.

The cooler/dispenser 10 and the components on the cooler/dispenser 10 are preferably dimensioned to comply with ADA requirements. More particularly, the cooler/dispenser 10 is preferably configured with the spout 36 a distance L1 from the floor corresponding to ADA requirements, currently 36″. The cooler/dispenser 10 is also preferably configured having a clear floor space of an ADA compliant distance, currently 30″ by 48″, in front of a free-standing or wall/post mounted drinking fountain (such a wall/post mounted unit preferably has a an ADA compliant clear knee space, currently 27″ high and 20″ wide). The spout 36 is preferably in the front of the unit an ADA compliant distance, currently 36″ from the floor, and preferably provides a stream of water parallel to the front of the unit an ADA compliant height, currently at least 4″ high, to allow use of a cup. The controls are preferably easy to operate without grasping, pinching, or twisting of the wrist. The top of the cooler/dispenser 10 is a distance L2 above the height of the spout 36, such as nine inches or the like.

The cooler/dispenser 10 may also include any variety of known electricalmechanical elements necessary to effect proper operation of the cooler/dispenser, such as relays, grommets, power cords, brackets, wiring, screws, etc. The cooler/dispenser 10 can be formed of a suitable durable plastic material, such as polycarbonate plastic or the like. The cooler/dispenser may also be arranged to have a solid color there through to avoid nicking and scratching. Of course, other suitable materials can be used in fabricating the cabinet of this invention. Likewise, the specific designs or the specific methods for joining the components can vary somewhat, as well, without departing from the thrust of this invention.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A bottled liquid cooler/dispenser comprising:
a housing configured to receive a bottled liquid container;
a maneuvering aid gate including a drain and a faucet, the gate being pivotally attached to the housing; and
an access door pivotally mounted on the front of the housing to swing between a closed and an open position.

2. The bottled liquid cooler/dispenser according to claim 1, wherein said bottled liquid cooler/dispenser is compliant with the American's with Disabilities Act.

3. The bottled liquid cooler/dispenser according to claim 1, further comprising liquid holder, a pump, and a cooling device contained within said housing.

4. The bottled liquid cooler/dispenser according to claim 1, further comprising a liquid holder, a pump, and a heating device contained within said housing.

5. The bottled liquid cooler/dispenser according to claim 1, wherein said housing is a generally rectangular housing with a front side and a bottom side.

6. The bottled liquid cooler/dispenser according to claim 5, further comprising an access door positioned proximate the bottom side.

7. The bottled liquid cooler/dispenser according to claim 5, further comprising a recess on the front side.

8. The bottled liquid cooler/dispenser according to claim 7, further comprising a faucet for hot liquid mounted on the recess.

9. The bottled liquid cooler/dispenser according to claim 8, wherein said faucet for hot liquid comprises a handle with indicia to enable users to quickly identify whether said faucet is for hot liquid.

10. The bottled liquid cooler/dispenser according to claim 8, wherein said faucet for hot liquid comprises a handle with coloring to enable users to quickly identify whether said faucet is for hot liquid.

11. The bottled liquid cooler/dispenser according to claim 8, wherein said faucet for hot liquid comprises a handle with Braille to enable users to quickly identify whether said faucet is for hot liquid.

12. The bottled liquid cooler/dispenser according to claim 5, further comprising a faucet for cold liquid mounted on the recess.

13. The bottled liquid cooler/dispenser according to claim 12, wherein said faucet for cold liquid comprises a handle with indicia to enable users to quickly identify whether said faucet is for cold liquid.

14. The bottled liquid cooler/dispenser according to claim 12, wherein said faucet for cold liquid comprises a handle with coloring to enable users to quickly identify whether said faucet is for cold liquid.

15. The bottled liquid cooler/dispenser according to claim 12, wherein said faucet for cold liquid comprises a handle with Braille to enable users to quickly identify whether said faucet is for cold liquid.

16. The bottled liquid cooler/dispenser according to claim 1, wherein said maneuvering aid gate has a top and said drain is positioned within a concave surface proximate the top of said maneuvering aid gate.

17. The bottled liquid cooler/dispenser according to claim 16, wherein said maneuvering aid gate comprises a push bar for activating the fountain when said maneuvering aid gate is in a closed position.

18. The bottled liquid cooler/dispenser according to claim 17, wherein said cooler/dispenser is configured as a gravity liquid cooler/dispenser when said maneuvering aid gate is in the closed position.

19. The bottled liquid cooler/dispenser according to claim 16, wherein maneuvering aid gate comprises a push bar for activating the fountain when said maneuvering aid gate is an open position.

20. The bottled liquid cooler/dispenser according to claim 19, wherein said cooler/dispenser is configured is configured to pump liquid from a holder to the faucet when said maneuvering aid gate is in the open position.
